(19) United States
(12) Patent Application Publication
(10) Pub. No.: US 2012/0125364 A1
(43) Pub. Date: May 24, 2012

(54) AUTOMATED RECEPTACLE CLEANING APPARATUS AND METHOD

(76) Inventors: Patrick John Wiley, Boise, ID (US); James William Joyce, Boise, ID (US)

(21) Appl. No.: 13/299,236

(22) Filed: Nov. 17, 2011

Related U.S. Application Data
(60) Provisional application No. 61/415,290, filed on Nov. 18, 2010.

(51) Int. Cl. B08B 9/093; B08B 3/02; B08B 3/08

(52) U.S. Cl. 134/10; 134/133; 134/110; 134/104.2; 134/105

(57) ABSTRACT

A self-contained, mobile system for cleaning trash receptacles. The system comprises a water system and a lift system that work in conjunction with each other to provide an automated method for cleaning trash receptacles. The system may be adapted to clean

### RELATED APPLICATIONS

This application claims the benefit of U.S. Provisional Patent Application Ser. No. 61/415,290, filed Nov. 18, 2010.

### BACKGROUND

1. The Field of the Invention

This invention relates to processes for industrial washing, and, more particularly, to cleaning of waste receptacles such as garbage cans, recycling containers and the like.

2. Background

Trash receptacles (bins, totes, carts) used out of doors to transport various waste materials from a residence now come in a relatively standard form. Such trash receptacles are adapted for mechanical handling by refuse trucks. They are generally cylindrical with a lid on a hinge and a bottom that includes wheels.

The types of materials that are transported in these receptacles may be varied. A residence or business may have multiple bins or receptacles. Often one receptacle is used for combined trash materials considered waste and not easily recyclable, while another receptacle is used for certain types of materials designated for recycling. Moreover, there may be more than one receptacle used for different types of recycling to further separate recyclable materials, i.e., a receptacle for paper recyclables and another receptacle for plastic recyclables.

The relatively standardized forms of trash receptacles has allowed for an automated process for gathering and removing the various types of waste. Garbage or refuse trucks that allow for mechanized, even somewhat automated gathering and transport of the various types of waste are well-known fixtures.

Trash receptacles accumulate persistent residues, often with associated odors. The process for cleaning trash receptacles at the point of use is not frequently employed and has not changed in the same manner as the process for gathering and transporting waste materials. Generally, if someone wants clean trash receptacles, they will have to clean the trash receptacles themselves, typically with a garden hose, by hand For example, one may spray the inside of the receptacle with a garden hose in an attempt to at least rinse out the receptacle. A more determined person may include some sort of scrubbing of the inside of the receptacle with a brush, rag or mop, followed by rinsing the receptacle.

What is needed then, whether recognized or not in the garbage industry, is a mechanized, even automated, non-personal-contact, relatively inexpensive method of cleaning the various trash receptacles. A portable system that could quickly and easily clean trash receptacles would provide a valuable service for improving cleanliness. It would be a further advantage to have a system that can clean multiple trash receptacles sequentially or simultaneously.

### BRIEF SUMMARY OF THE INVENTION

In accordance with the foregoing, certain embodiments of an apparatus and method in accordance with the invention provide a self-contained, automated system for cleaning trash receptacles. A water system and lift system work in conjunction with each other to accomplish this.

The water system may comprise a cleaning tank that contains a cleaning solution, a pump that is used to spray the cleaning solution into the receptacles to be cleaned, and a collection tank used to collect and reuse the cleaning solution. The lift system may comprise a lift or arm that can engage and move the trash receptacles. The lift system may be a hydraulic system that can move the trash receptacles from their original position, to a position where they can be cleaned, and back to the original position.

The water system and the lift system operate in coordination with each other to clean the trash receptacles. For example, the apparatus may move into position next to a trash receptacle to be cleaned. The lift system may engage the receptacle and then move the receptacle into a position to be cleaned. The water system may then dispense the cleaning solution into the receptacle and clean out the inside of the receptacle. The lift system then returns the trash receptacle to its original position. The water system collects and reuses the cleaning solution so a minimal amount of cleaning solution is used to clean multiple trash receptacles. This system minimizes use of water, minimizes hauling weight, and does not waste cleaning solution.

One embodiment of the present system cleans a trash receptacle using a multi-stage process. For example, a trash receptacle is sprayed with a washing solution to remove the majority of debris and residue and then sprayed with a cleaning or disinfectant solution to sterilize the receptacle. The respective solutions are maintained in separate tanks and used independently.

One embodiment of the present system cleans one trash receptacle during a single cycle. One embodiment of the present system cleans multiple trash receptacles during a single cycle. Both embodiments may be used with the various types of trash receptacles used by the majority of residences.

### BRIEF DESCRIPTION OF THE DRAWINGS

The foregoing features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is a rear perspective view of one embodiment of a system for cleaning trash receptacles in accordance with the invention with two receptacles in a loading mode;

FIG. 2 is a frontal perspective view of the embodiment of FIG. 1;

FIG. 3 is a top plan view of the embodiment of FIGS. 1 and 2 with two receptacles in a loading mode;

FIG. 4 is a bottom plan view of the embodiment of FIGS. 1 and 2;

FIG. 5 is a right side elevation view of the embodiment of FIGS. 1 and 2 with two receptacles in a loading mode;

FIG. 6 is a left side elevation view of the embodiment of FIGS. 1 and 2;

FIG. 7 is a front elevation view of the embodiment of FIGS. 1 and 2;

FIG. 8 is a rear elevation view of the embodiment of FIGS. 1 and 2;

FIG. 9 is a rear perspective view of one embodiment of a system for cleaning trash receptacles in accordance with the invention with two receptacles in a loading mode;

FIG. 10 is a rear perspective view of the embodiment of FIG. 9 with two receptacles in a cleaning mode;

FIG. 11 is a top plan view of the embodiment of FIG. 9;

FIG. 12 is a bottom plan view of the embodiment of FIG. 9;

FIG. 13 is a right side elevation view of the embodiment of FIG. 9 with a receptacle in a loading mode;

FIG. 14 is a right side elevation view of the embodiment of FIG. 9 with a receptacle in a loading mode;

FIG. 15 is a front elevation view of the embodiment of FIG. 9;

FIG. 16 is a rear elevation view of the embodiment of FIG. 9 with two receptacles in a loading mode;

FIG. 17 is a right side elevation view of the embodiment of FIG. 9 with a receptacle in a cleaning mode;

FIG. 18 is a rear elevation view of the embodiment of FIG. 9 with two receptacles in a cleaning mode; and

FIG. 19 is a rear perspective view of the embodiment of FIGS. 1 and 2.

### DETAILED DESCRIPTION OF THE PREFERRED EMBODIMENTS

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention, as claimed, but is merely representative of various embodiments of the invention. The illustrated embodiments of the invention will be best understood by reference to the drawings, wherein like parts are designated by like numerals throughout.

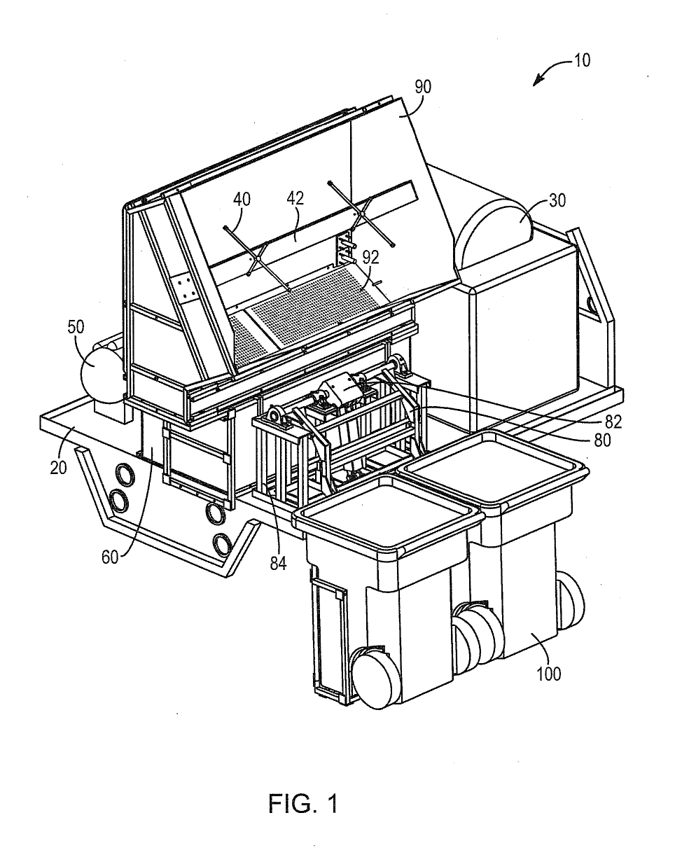

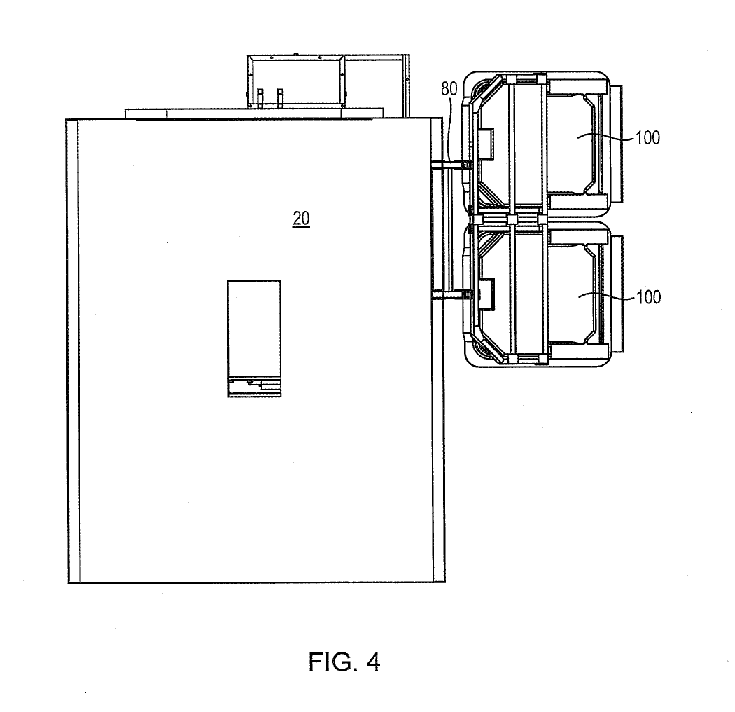

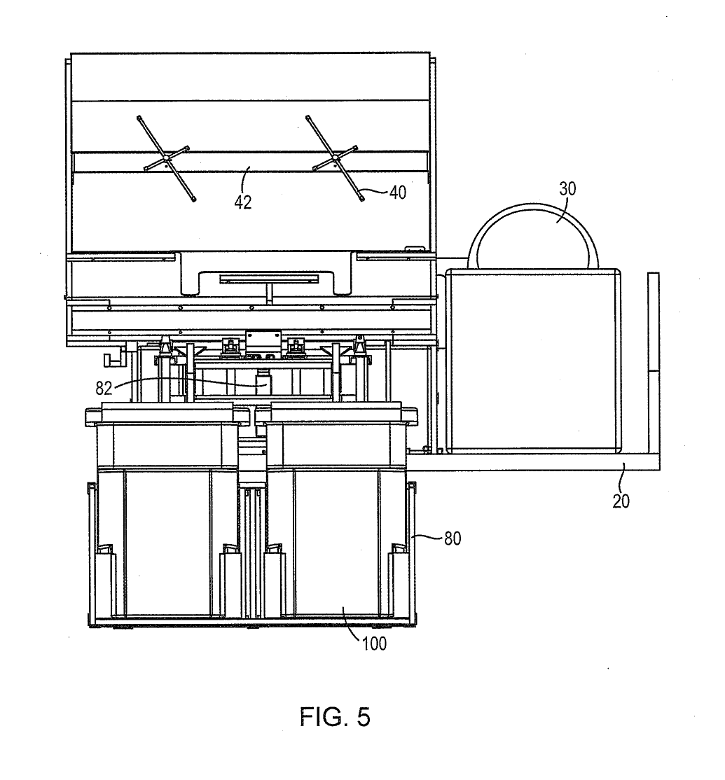

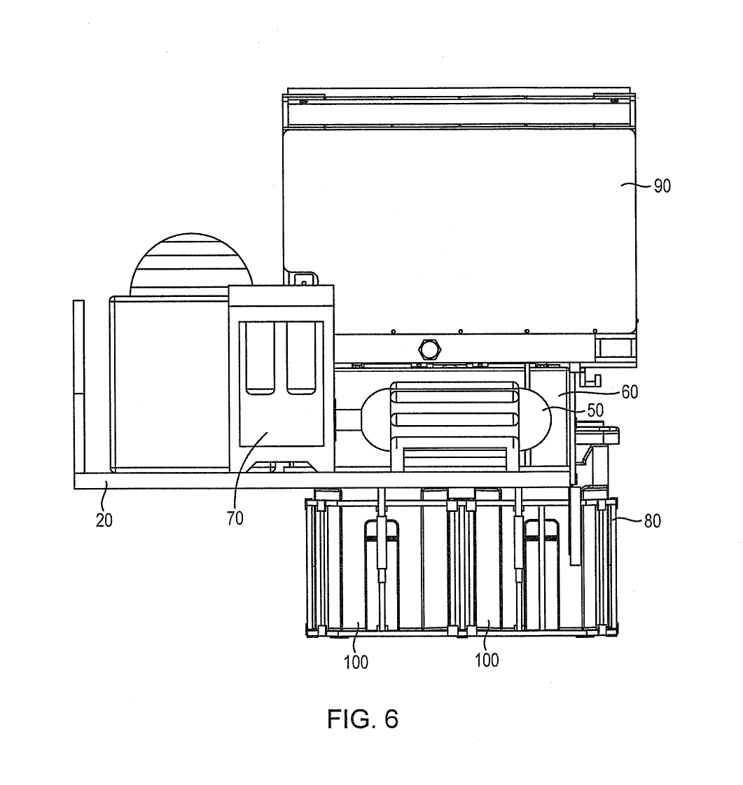

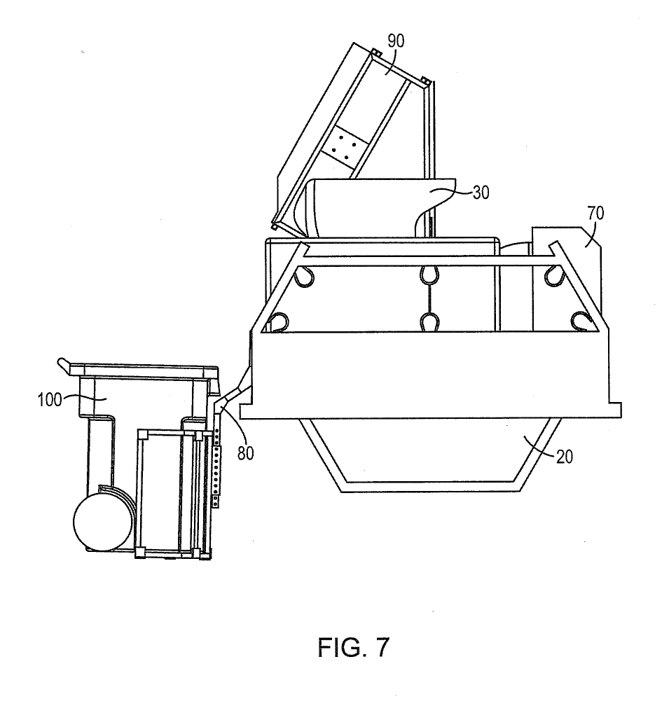

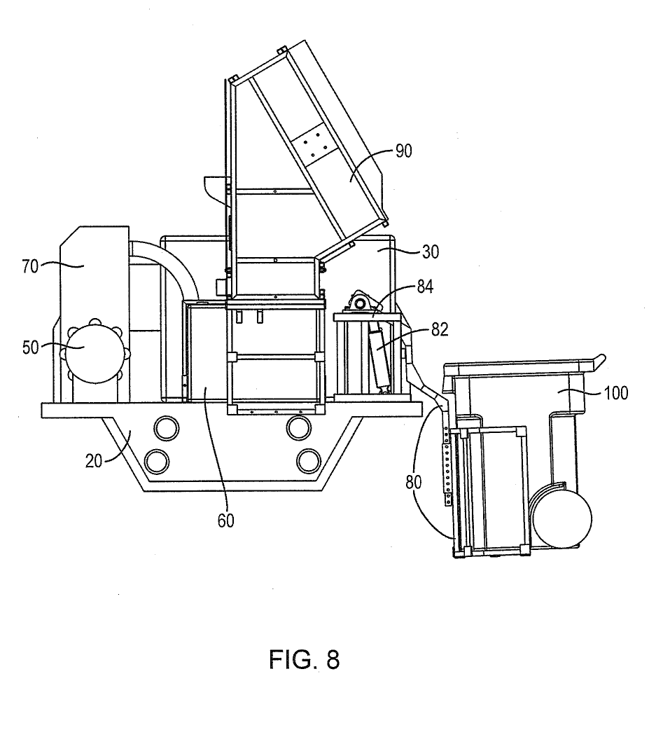

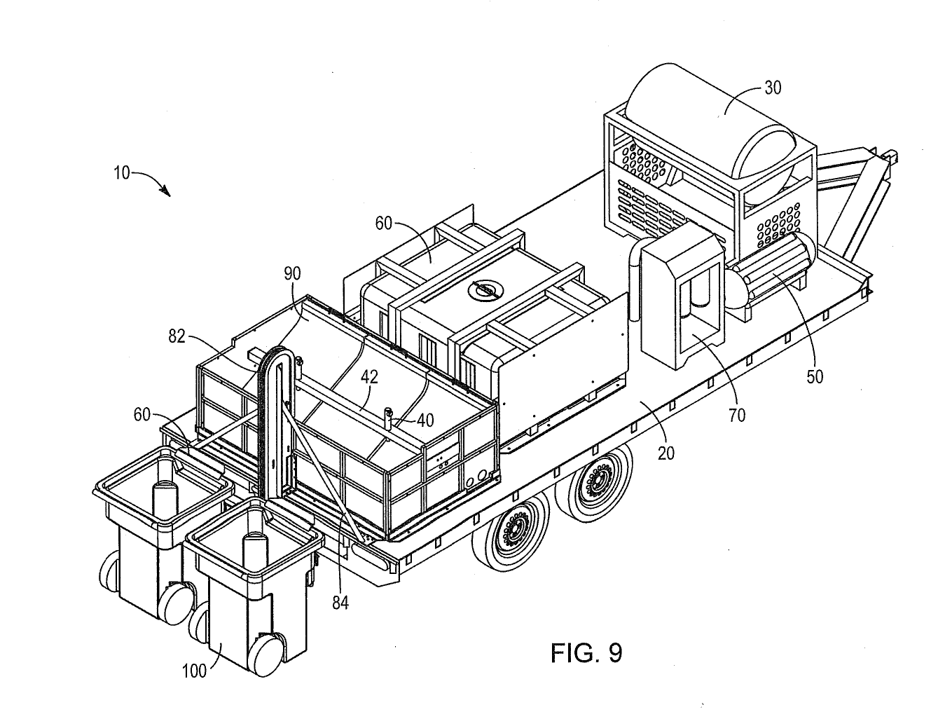

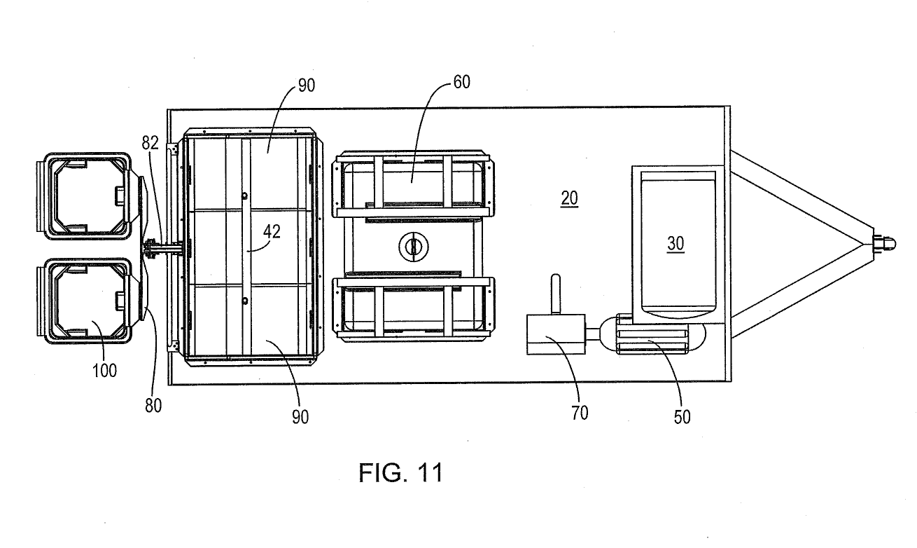

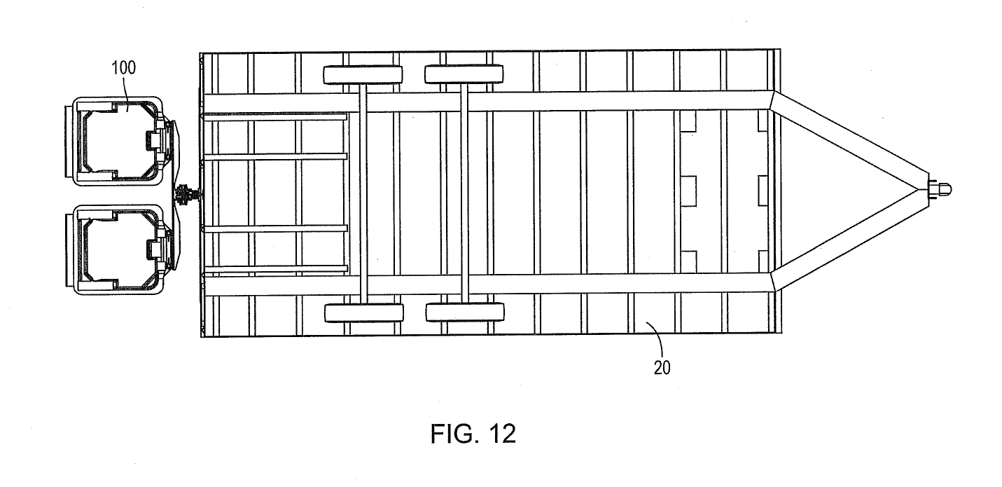

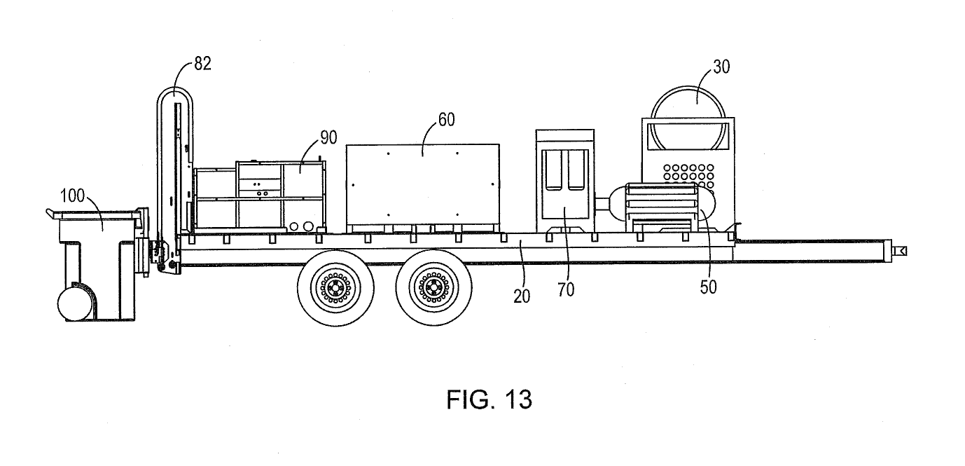

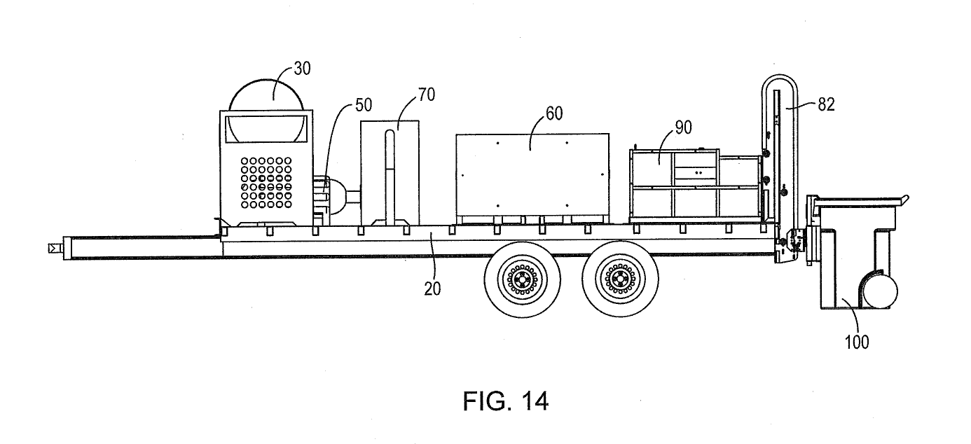

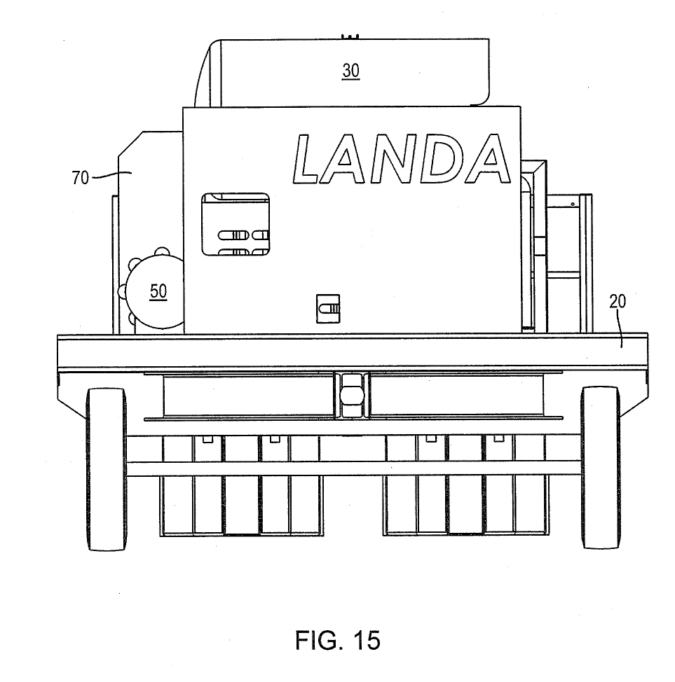

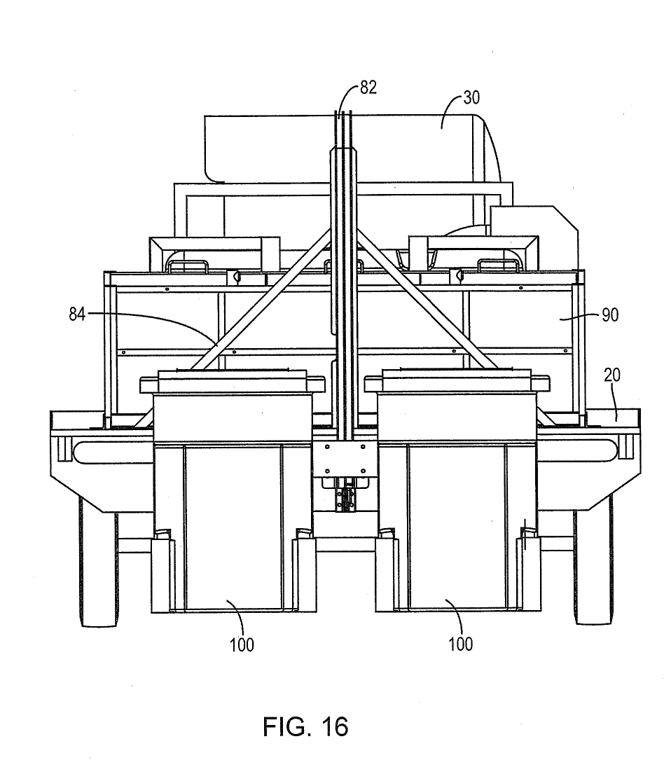

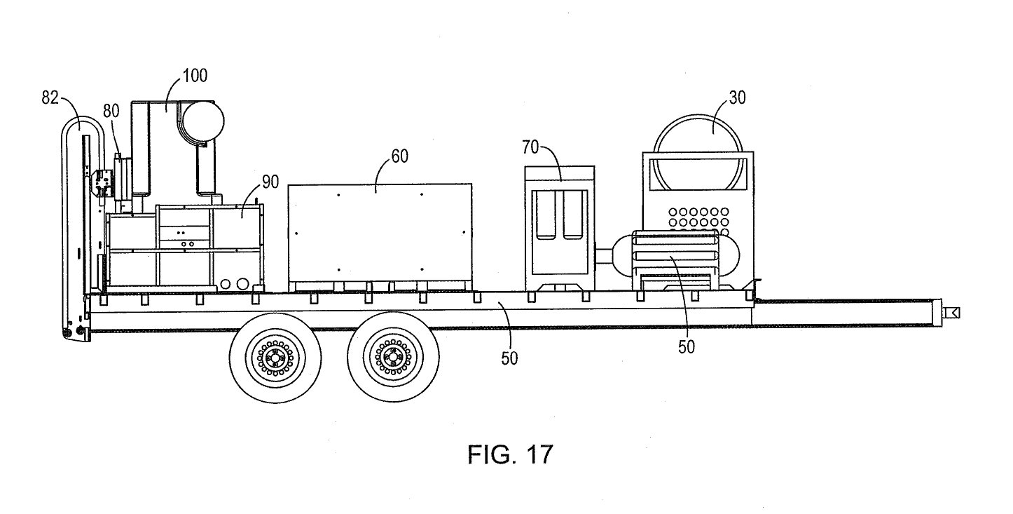

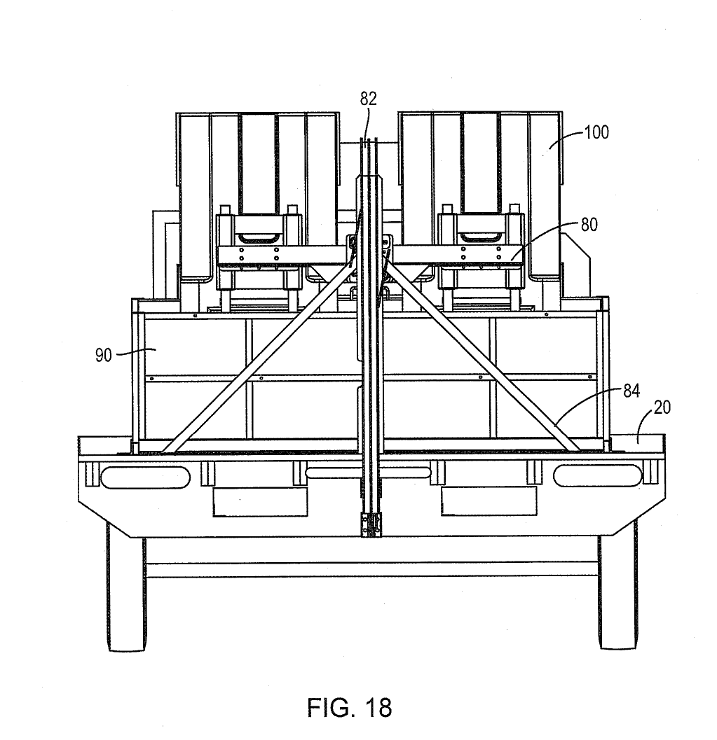

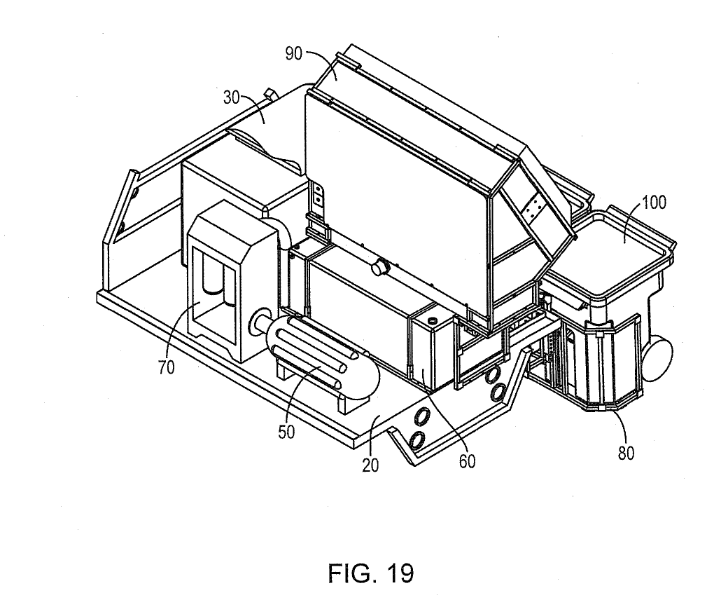

Referring to FIGS. 1-19, an apparatus 10 or system 10 in accordance with the invention may be configured to be self-contained and mobile. The system 10 may be configured to be transported on a flat surface, such as a flat-bed truck (see especially FIGS. 1-8 and 19) or a trailer (see especially FIGS. 9-18), or may be configured to be transported by alternate means, such as a regular pick-up truck. The system 10 may also be configured to be stationary.

The system 10 may be described as having a water system and a lift system working in cooperation to clean a receptacle. The water system may be described as facilitating the movement and collection of a cleaning solution used to clean the receptacles. The water system may also include filtering and heating of the cleaning solution. The lift system may be described as facilitating the positioning of the receptacles through the process of loading, cleaning, and returning the receptacles throughout the cleaning process.

Referring to FIGS. 1-19, the water system may be comprised primarily of a pressurizing pump 30, wands or sprayers 40, a first tank or cleaning tank 50, and a second tank or collection tank 60. The water system may include additional components to aid in the cleaning and collection process. For example, a heater (not pictured) may be included with the pump 30 to heat the cleaning solution used to clean the receptacles 100. Also, a cover or shroud 90 may be used to help prevent over-spray into the surrounding environment and collect more cleaning solution during and after the receptacles are sprayed during the cleaning process.

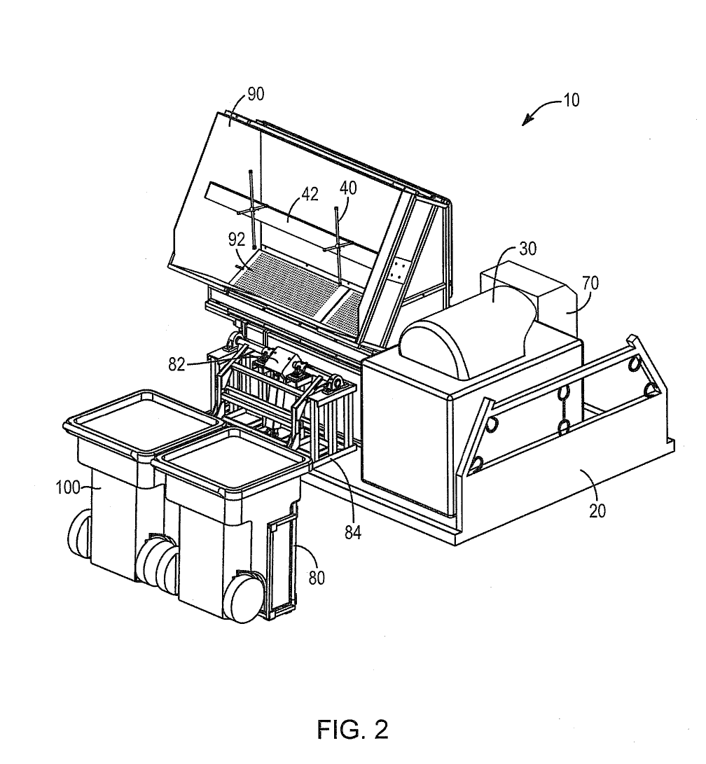

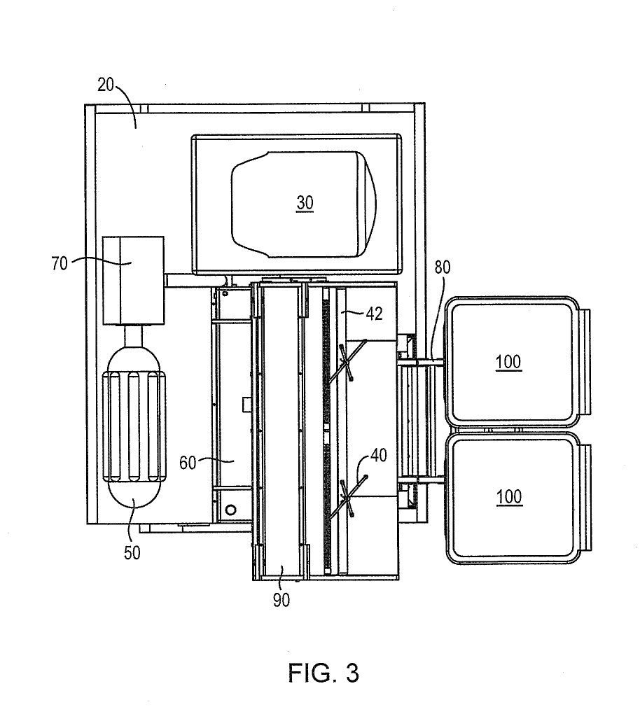

The first tank or cleaning tank 50 may be of any suitable size and shape, and may be composed of any suitable material, especially non-corroding materials, such as stainless steel or polymers like polyethylene plastic. In one embodiment, the cleaning tank 50 has a circular cross-section, as depicted in FIGS. 2 and 3.

However, other cross-sections are likewise extremely common, such as a square cross-section tank. The shape or size of the cleaning tank 50 should be such that the system 10 may be self-contained, mobile and provide enough volume to perform a suitable number of cleaning cycles. The cleaning tank 50 contains the cleaning solution to be used in the cleaning process.

The cleaning solution may be any solution suitable for spraying the inside of the receptacles 100. For example and not by way of limitation, the cleaning solution may be water, alone or treated such as by a detergent or a disinfecting solution. The disinfecting solution may include any suitable disinfecting agent such as an alcohol, an aldehyde, a phenolic, a quaternary ammonium compound, an oxidizing agent, or the like.

The oxidizing agents may include sodium hypochlorite, chlorine, chlorine dioxide, ozone, lactic acid, acidic electrolyzed water, or the like. Disinfecting solutions are used to provide an extra measure of cleanliness to the receptacles after the cleaning process. Detergents may help free debris and dried liquid materials or residues from the walls of the receptacle to be cleaned. Some materials like ammonia act as both detergents and disinfectants.

The cleaning tank 50 is fluidly connected to the pump 30. The pump 30 may be any pumping mechanism suitable for transferring the cleaning solution from the cleaning tank 50 to the sprayers 40. The pump 30 should be corrosion resistant, not easily jammed, and also be able to generate enough water pressure to facilitate the cleaning of the inside of the receptacles 100 when the cleaning solution is sprayed through the sprayers 40 and into the receptacles. Rotary impeller pumps and centrifugal pumps generally appear to be suitable, and available in non-reactive polymers. The pump 30 may be fluidly connected to a fluid line 42 such that the cleaning solution may be pumped from the cleaning tank 50 through the pump 30 and through the fluid line 42 to the sprayers 40. In one embodiment, the pump is provided as part of a Landa® brand specialized, pressure washer package.

The pressure washer package or pump 30 may also include a heater for heating the cleaning solution before it is sprayed into the receptacles 100, as well as a built-in generator for producing the electricity to drive controls and serve as a pump to power the hydraulics for the lift system described hereafter, or the like.

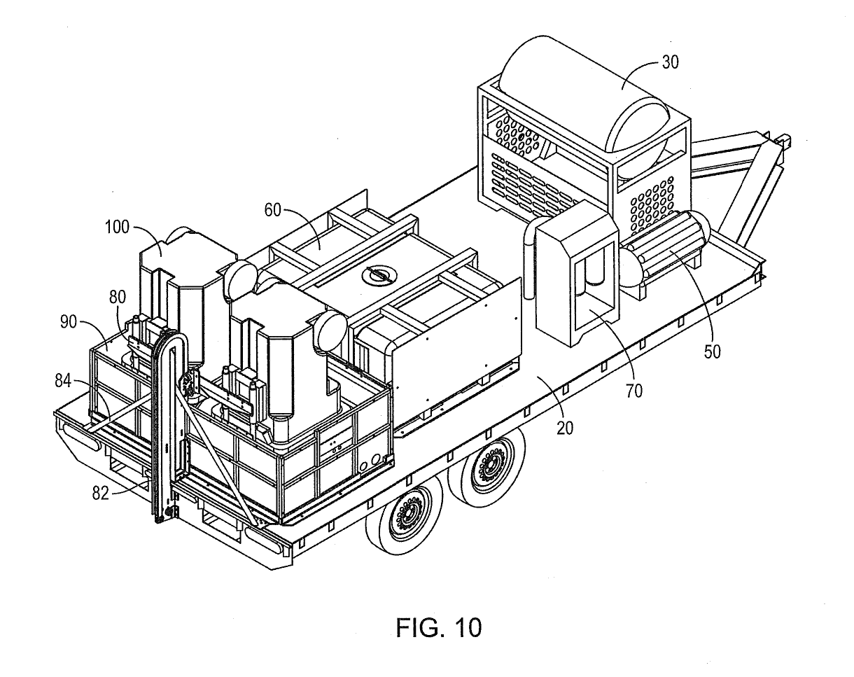

The wand or sprayer 40 may be configured in any manner that will facilitate the spraying of the cleaning solution into the receptacle 100 when the receptacle is in the cleaning position, as shown in FIGS. 10, 17 and 18. For example the sprayer 40 may extend into the receptacle to a greater or lesser depth, may spin or not spin, and may have any suitable number and direction of jets. The sprayer 40 may be composed of any suitable material, such as stainless steel or polyethylene plastic.

The system 10 may be configured to have one sprayer 40 or to have multiple sprayers 40. As shown in FIGS. 1-3 and 5, the sprayers 40 may be configured like wands that include jets, small holes or apertures at each end of the wands, or at each end of the wands and along the shaft of the wands.

The jets may be oriented such that the sprayers 40 may be attached to a fluid line 42 that is in fluid connection with the pump 30. The sprayers 40 may be attached to the fluid line 42 at an approximate midpoint of the sprayers 40. The sprayers 40 begin to spin when the cleaning solution is being pumped through them. The sprayers 40 may be configured to spin near the opening of the receptacles 100 when the receptacles are in the cleaning position. Alternatively, or in addition, the sprayers 40 may be configured to spin and extend a certain distance into the receptacles 100 when the receptacles are in the cleaning position.

In one embodiment, pictured in FIGS. 1, 2, 9 and 10, a cover or shroud 90 may be positioned around the opening of the receptacles 100 when the receptacles are in the cleaning position, as shown more specifically in FIG. 10. The shroud 90 may be a thin sheet of material shaped to cover or enclose all or a portion of the area around the opening of the receptacles 100 when the receptacles are in the cleaning position.

A benefit of the shroud 90 is to help arrest splashing back of the cleaning solution used during the cleaning process when the cleaning solution is forcefully directed or re-directed toward the collection tank 60 and may splash back as a result. The shroud 90 helps to increase the collection of the cleaning solution and to help make sure cleaning solution does not get spilled onto the area surrounding the system 10 during the cleaning process.

In one embodiment and as pictured in FIGS. 1 and 2, a shroud 90 may also include a screen 92. The screen 92 may be a thin sheet of material with suitably sized holes positioned to separate debris from the cleaning solution after the cleaning solution is sprayed into a receptacle 100, but before the cleaning solution enters the collection tank 60. The screen 92 may be composed of any suitable material, such as stainless-steel, polyethylene plastic, or the like.

The second tank 60 or collection tank 60 may be of any suitable size and shape, and may be composed of any suitable material, such as stainless steel, polyethylene plastic, or the like. In one embodiment, the collection tank 60 has a square cross-section, as depicted in FIGS. 1, and 8-10. The shape or size of the collection tank 60 may be such that the system 10 is self-contained, mobile, and provides enough volume to support a suitable number of cleaning cycles. The collection tank 60 contains the cleaning solution collected after the cleaning cycle for each receptacle 100. The collection tank 60 has an opening near the top where the cleaning solution that has been used in the cleaning process may be directed into the collection tank 60.

In one embodiment, the collection tank 60 is fluidly connected to the cleaning tank 50 so that cleaning solution may be transferred from the collection tank 60 to the cleaning tank 50. An additional pump may be utilized to transfer the cleaning solution as described. In this manner, the system 10 recycles the cleaning solution used during the cleaning process so that a minimal amount of cleaning solution may be used during multiple cleaning cycles for multiple receptacles. Accordingly, the collection tank 60 may be fluidly connected to the cleaning tank 50 and any additional pump or filter that may be contained in a housing 70.

In one embodiment, the collection tank solution may be used for a first, bulk removal of material. Then, the solution from the clean tank may be used for a final rinse and disinfectant, or rinsing solution, or the like. In this case, the collection tank need not be ported into the original cleaning solution tank. Each tank may have independent pumps or filters as necessary for the desired, intended cleaning process.

The recycling of the cleaning solutions from the collection tank 60 to the cleaning tank 50 may also include a filtering stage. For example, a filter may be used to filter the cleaning solution being transferred from the collection tank 60 to the cleaning tank 50. The filter may be in fluid communication with and between the collection tank 60 and the cleaning tank 50.

In one embodiment, any pumps or filters necessary for the completion of the desired cleaning process may be contained in a housing 70. The housing 70 may be of any suitable size and shape, and may be composed of any suitable material, such as stainless steel, polyethylene plastic, or the like. In one embodiment, the housing 70 has a square cross-section, as depicted in FIGS. 2-3 and 9-10. The shape or size of the housing 70 may be such that the system 10 is self-contained, mobile, and provides enough volume to support a suitable number of cleaning cycles.

The housing 70 may contain any pump mechanism or filter mechanism suitable for completing the desired cleaning process. For example, the housing may contain a pump for moving cleaning solution from the collection tank 60 to the cleaning tank 50. The housing 70 may also include a filter that filters the cleaning solution before it is moved from the collection tank 60 to the cleaning tank 50. The housing 70 may also contain multiple pumps when the desired cleaning process includes multiple steps, such first cleaning a receptacle with a cleaning solution and then rinsing that receptacle with a disinfectant solution.

The lift system may include a lift or arm 80. The arm 80 may be controlled by any system that enables the arm 80 to lift a receptacle 100 off the ground. For example, the arm 80 may include any structure suitable for engaging a receptacle 100, as well as support structure 84 suitable for stabilizing the lift system on the platform 20. The arm 80 may be controlled by a hydraulic system 82 that lifts the engaged receptacle 100 from an original position on the ground to a cleaning position, as shown more specifically in FIGS. 1, 2, 9 and 10.

The hydraulic system 82 may include a piston that extends and contracts to move the arm 80, as in FIGS. 1 and 2. The hydraulic system 82 may include a track or chain or the like that lifts and inverts a receptacle, as in FIGS. 9 and 10. The support structure 84 for the hydraulic system 82 can likewise be adjusted to accommodate the specific hydraulic system 82 used. The arm 80 may then return the receptacle 100 to the original position after the cleaning process has been completed.

In one embodiment, and as shown in FIGS. 1 and 2, the arm 80 may be configured with a rack or shelf that engages the receptacle 100 from the bottom. In another embodiment (not pictured), the arm may be configured like a clamp or pincer or fork that engages the receptacle around the approximate middle of the receptacle. In another embodiment, and as shown in FIGS. 9, 10, 17, and 18, the arm 80 may be configured to removably attach to a portion of the receptacle 100.

The method or cleaning process may include variable steps depending on the configuration of the system 10. In one embodiment, a typical cleaning process or cleaning cycle may comprise positioning the system 10 to engage a receptacle 100 to be cleaned. The arm 80 from the lift system may then engage the receptacle 100 so the receptacle 100 may be moved from its original position on the ground to a cleaning position.

Once in the cleaning position, the receptacle 100 may be cleaned as the system 10 sprays cleaning solution through the sprayers 40 and into the receptacle 100. The cleaning solution may then be collected to be used again later. The receptacle 100 may then be returned to its original position. The system 10 may then move on to repeat this process with another receptacle.

This cleaning process may be adjusted depending on the configuration of the system 10. For example, the system 10 or pump 30 may include a heater that heats the cleaning solution before it is sprayed into the receptacle 100. As another example, the system 10 or pump 30 or housing 70 may include a filter that filters the cleaning solution after it is collected in the collection tank 60 and before it is transferred to the cleaning tank 50 to be reused. The remainder of the cleaning process may be essentially unchanged by the addition of either or both of these steps of heating and filtering.

The receptacle 100 to be cleaned maybe any receptacle 100 of suitable size and shape that may be engaged by the system 10. The receptacle 100 may be a traditional trash can, or a plastic bin or cart style with a lid on a hinge and wheels on its base. The receptacle 100 may be made of any suitable material. The receptacle 100 may be used to contain any type of waste material, such as recyclable, non-recyclable, wet, or dry waste.

While the system 10 may be configured to be mobile, the system 10 may also be configured to be stationary and still operate in much the same way. A stationary system 10 may include all the primary components described above and operate in much the same manner. In a stationary embodiment, the platform 20 or bed of the system 10 may be the ground or any suitable built-up platform.

Any tank or pump used in a stationary system may be enlarged or otherwise modified to enable more repetitions of the cleaning process, or even provide a virtually continual supply of cleaning materials. One difference between a mobile system 10 and a stationary system 10 is that someone wanting to clean a receptacle 100 using the system 10 may position the receptacle 100 to be cleaned where the arm 80 may engage the receptacle 100. This position then corresponds to the original position described above. Again, the system 10 may be configured to clean one receptacle during a given cleaning cycle or multiple receptacles during a cleaning cycle.

The stationary system 10 may or may not include a heater for heating the cleaning solution used in the cleaning process. The stationary system 10 may or may not include a filter for filtering the cleaning solution as it is prepared to be reused and transferred between the collection tank 60 and the cleaning tank 50.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed and desired to be secured by United States Letters Patent is:

1. An apparatus for cleaning waste receptacles, the apparatus comprising:
an arm positioned to engage a receptacle at an original position and moving the receptacle into a cleaning position and back to the original position;
a first tank fluidly connected to a pressurizing pump;
the pressurizing pump fluidly connected to sprayers;
the sprayers positioned to spray a cleaning solution into the receptacle in the cleaning position;
a second tank positioned to collect the cleaning solution after use; and
the second tank fluidly connected to the first tank allowing to transfer the cleaning solution from the second tank to the first tank.

2. The apparatus of claim 1, further comprising:
a filter fluidly connected between the second tank and the first tank to filter the cleaning solution transferred from the second tank to the first tank.

3. The apparatus of claim 1, further comprising:
a shroud positioned around the sprayers to capture the used cleaning solution and directing the cleaning solution into the second tank.

4. The apparatus of claim 1, wherein the pressurizing pump includes a heater heating the cleaning solution.

5. The apparatus of claim 1, wherein the cleaning solution is a disinfecting solution.

6. The apparatus of claim 5, wherein the cleaning solution includes a disinfecting agent selected from the group consisting of an alcohol, an aldehyde, a phenolic, a quaternary ammonium compound, and an oxidizing agent.

7. The apparatus of claim 1, wherein the sprayers extend from a first position to a second position, and the second position positioning the sprayers at least six inches inside the receptacle.

8. The apparatus of claim 1, wherein the arm can engage and move more than one receptacle.

9. The apparatus of claim 8, further comprising:
at least two sprayers, each cleaning a receptacle simultaneously.

10. A method for automated cleaning of receptacles, the method comprising:
selecting a receptacle to be cleaned;
operating a hydraulic arm capable of engaging and moving the receptacle from an original position to a cleaning position and back to the original position;
engaging the receptacle;
moving the receptacle into the cleaning position;
spraying the inside of the receptacle with a cleaning solution;
collecting a residual of the cleaning solution;
recycling the residual to be used again; and
replacing the receptacle to the original position.

11. The method of claim 10, further comprising:
filtering the residual cleaning solution after collecting any residual cleaning solution.

12. The method of claim 10, further comprising:
warming the cleaning solution before spraying the inside of the receptacle with the cleaning solution.

13. The method of claim 10, further comprising:
rinsing the receptacle with a rinsing solution.

14. The method of claim 10 wherein the cleaning solution is a disinfecting solution.

15. The method of claim 14 wherein the cleaning solution includes a disinfecting agent selected from the group consisting of an alcohol, an aldehyde, a phenolic, a quaternary ammonium compound, or an oxidizing agent.

16. A method for automated cleaning of multiple receptacles, the method comprising:
providing at least two receptacles to be cleaned;
actuating a hydraulic arm moving the receptacles from an original position to a cleaning position and back to the original position;
capturing the receptacles simultaneously;
moving the receptacles into the cleaning position;
spraying the inside of the receptacles with a cleaning solution;
collecting a residual of the cleaning solution;
recycling the residual to be used again; and
replacing the receptacles to the original position.

17. The method of claim 16, further comprising:
filtering the residual cleaning solution after collecting any residual cleaning solution.

18. The method of claim 16, further comprising:
warming the cleaning solution before spraying the receptacle with the cleaning solution.

19. The method of claim 16 wherein the cleaning solution is a disinfecting solution.

20. The method of claim 19 wherein the cleaning solution includes a disinfecting agent selected from the group consisting of an alcohol, an aldehyde, a phenolic, a quaternary ammonium compound, or an oxidizing agent.
